(19) United States
(12) Patent Application Publication
(10) Pub. No.: US 2010/0023380 A1
(43) Pub. Date: Jan. 28, 2010

(54) METHOD AND APPARATUS FOR PERFORMING WEB ANALYTICS

(76) Inventor: Duff Anderson, Verdun (CA)

Correspondence Address: KOLISCH HARTWELL, P.C., 200 PACIFIC BUILDING, 520 SW YAMHILL STREET, PORTLAND, OR, 97204, US

(21) Appl. No.: 12/494,140

(22) Filed: Jun. 29, 2009

Related U.S. Application Data
(60) Provisional application No. 61/076,824, filed on Jun. 30, 2008.

(51) Int. Cl. G06Q 10/00; G06F 3/01; G06Q 50/00

(52) U.S. Cl. 705/10; 715/733

(57) ABSTRACT

A graphical user interface implemented on a computer. The graphical user interface has an information area displaying customer satisfaction data generated on the basis of on-line surveys through application of a questionnaire to visitors of a web site, wherein the questionnaire includes open-ended questions. The graphical user interface further includes a control operable by a user at the computer to display answers provided by the visitors to the open-ended questions.

### CROSS REFERENCE TO RELATED APPLICATIONS

This application claims the benefit under 35 USC §119(e) of U.S. provisional patent application Ser. No. 61/076,824 filed Jun. 30, 2008 and presently pending. The contents of the above-mentioned patent application are incorporated herein by reference.

### FIELD OF THE INVENTION

The invention relates to methods and to a systems to manage survey data reflecting customer feedback in the context of online experiences.

### BACKGROUND OF THE INVENTION

A wide range of business organizations use elaborate web sites to conduct sales or to showcase their products or services. The computer industry is a specific example where a number of companies rely almost exclusively on online stores to commercialize their products. Such web sites tend to be elaborate and provide visitors with in depth information about product offerings. In addition, a user has the capability of customizing the products available for purchase such that they fit his/her needs and budget.

The automotive industry is another example of a business sector that relies heavily on online tools to showcase products. In this instance, web sites are usually not designed with the purpose of conducting sales; rather they are built with features to allow a potential customer to visualize all the details of product offerings including pricing.

When a web site is being designed, a number of factors are taken in consideration in order to provide visitors with a rich and satisfying experience. In many instances those factors can lead to conflicting requirements. For instance, it is always desirable to provide on a web site as much information as possible about a product or service, however as the amount of information included increases, so does the difficulty for a visitor for locating precisely what he/she seeks. Accordingly, the science of designing a web site that is as much user friendly as possible often requires finding the right balance between those conflicting requirements.

This balance is tends to vary over time as consumer perceptions shift and new trends develop in the online space. Accordingly, the web initiatives are rarely static and they evolve to follow consumer demands such as to maximize business opportunities.

In order to better understand the needs of online visitors business organizations collect and analyze survey data. The survey data is intended to reflect the actual visitor's online experience in the context of an actual visit. On the basis of the survey data the business organization can better understand the purchasing habits of customers and make the necessary adaptations in order to attract more customers or enhance the online experience of existing customers.

The survey data in connection with an online site is obtained by conducting a survey while a visitor is browsing the site. Typically, as the customer enters the site, a layer containing an invitation is presented to a random number of visitors asking the customer if he/she is willing to participate in the survey. If the visitor is willing to participate in the survey he/she is presented with a series of questions immediately following the end of their visit to the site, which for the most part tend to be of the closed-ended type (fixed number of select answers). Some surveys also provide the visitor with the opportunity to provide more substantive feedback by asking the person open ended questions. An open ended question would typically ask for input such as what the visitor finds the most likable or dislikable about the site, the features that could be improved, etc.

As the survey is run continuously, it produces a constant flow of survey data. This survey data is collected and analyzed. Survey data tends to be very difficult to analyze in order to extract useful information. There are many reasons for this. First and foremost, visitors provide a wide range of different answers to the questions in light of their individual perceptions and needs. Also the volume of data that is being collected is large. Accordingly, it is complex for an analyst to identify discernible trends owing to the variability of the answers.

Accordingly, there is a continuous need for improvement of the area of web analytics and in the manner of presentation of the analysis results such as to allow extracting useful visitor feedback information that is as much useful as possible.

### SUMMARY OF THE INVENTION

As embodied and broadly described herein the invention provides a graphical user interface implemented on a computer. The graphical user interface has an information area displaying customer satisfaction data generated on the basis of on-line surveys through application of a questionnaire to visitors of a web site, wherein the questionnaire includes open-ended questions. The graphical user interface further includes a control operable by a user at the computer to display answers provided by the visitors to the open-ended questions.

As embodied and broadly described herein, the invention also provides a computer readable storage medium including a program for execution by a computer to implement a graphical user interface. The graphical user interface has an information area displaying customer satisfaction data generated on the basis of on-line surveys through application of a questionnaire to visitors of a web site, wherein the questionnaire includes open-ended questions. The graphical user interface further includes a control operable by a user at the computer to display answers provided by the visitors to the open-ended questions.

As embodied and broadly described herein the invention also provides a method for collecting and presenting customer satisfaction data, the method including:
a) running an on-line survey through application of a questionnaire to visitors of a web site, wherein the questionnaire includes open-ended questions;
b) processing the responses to the questionnaire to generate customer satisfaction data;
c) creating a link in a database between the customer satisfaction data and answers provided by visitors to open-ended questions of the questionnaire;
d) displaying at a computer via a graphical user interface the customer satisfaction data;
e) providing the graphical user interface with a control, the control when operated by the user using the link to cause display to the user at the computer of answers to the open-ended questions.

As embodied and broadly described herein the invention also provides a graphical user interface implemented on a computer. The graphical user interface has a first information area displaying a company specific customer satisfaction data generated on the basis of an on-line survey through application of a questionnaire to visitors of a web site of the company. The graphical user interface also includes a second information area displaying industry wide customer satisfaction data generated on the basis of surveys of web sites of a plurality of companies.

As embodied and broadly described herein the invention also provides a computer readable storage medium including a program for execution by a computer to implement a graphical user interface. The graphical user interface has a first information area displaying a company specific customer satisfaction data generated on the basis of an on-line survey through application of a questionnaire to visitors of a web site of the company. The graphical user interface also includes a second information area displaying industry wide customer satisfaction data generated on the basis of surveys of web sites of a plurality of companies.

As embodied and broadly described herein the invention also provides a method for collecting and presenting customer satisfaction data, the method including:
a) running an on-line survey through application of a questionnaire to visitors of a web site associated with a certain company;
b) processing the responses to the questionnaire to generate company specific customer satisfaction data;
c) producing industry wide customer satisfaction data generated on the basis of surveys of web sites of a plurality of companies;
d) displaying at a computer via a graphical user interface the company specific and the industry wide customer satisfaction data, the displaying including:
   i) providing a first information area displaying the company specific customer satisfaction data;
   ii) providing a second information area displaying the industry wide customer satisfaction data.

### BRIEF DESCRIPTION OF THE DRAWINGS

A detailed description of examples of implementation of the present invention is provided hereinbelow with reference to the following drawings, in which:

FIG. 1 is a block diagram of a network, showing the interaction between a visitor and a web site during a survey conducted to obtain visitor feedback;

FIG. 2 is a more detailed diagram of the network shown in FIG. 1;

FIG. 3 is a flowchart of the process for conducting the survey;

FIG. 4 is a flowchart of a process for analyzing the responses to the survey to generate a consumer satisfaction report;

FIG. 5 on-screen display showing a graphical user interface (GUI) displaying to a user a consumer satisfaction metric and also allowing the user to query the report for underlying answers to open-ended questions;

FIG. 6 is an on-screen display of an information area allowing the user to run a first level filtering process to the answers to open-ended questions;

FIG. 7 is an on-screen display of an information area allowing the user to run a second level filtering process to the answers to open-ended questions;

FIG. 8 is an on-screen display of an information area that shows the results of the filtering operation performed via the information areas in FIGS. 7 and 8;

FIG. 9 is a diagram illustrating a data structure in which answers to open-ended questions are stored;

FIG. 10 is a flowchart of a process for extracting industry wide consumer satisfaction data;

FIG. 11 is an on-screen display showing a graphical user interface (GUI) for displaying to a user a company specific consumer satisfaction metric and also an industry wide consumer satisfaction metric; and

FIG. 12 is a block diagram illustrating the architecture of a computer based system for collecting customer feedback data from a variety of different sources.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

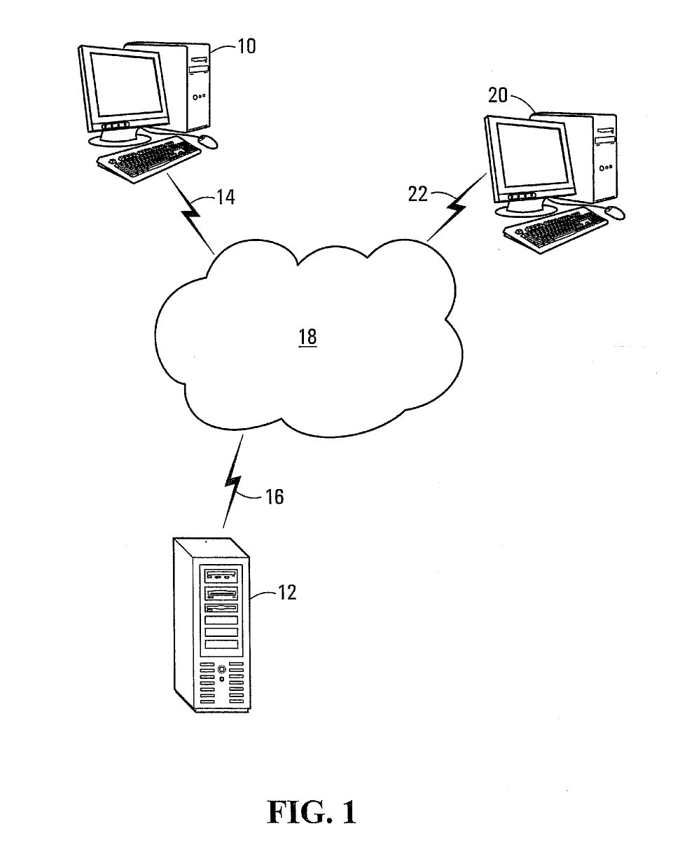

FIG. 1 is a general illustration of a network arrangement allowing a visitor to view a web site. The system includes a workstation 10 via which the user interacts with the website. The workstation 10 is computer based and it communicates with a server 12 that contains the necessary files which sent to the workstation 10 to implement the web site interaction. The workstation 10 and the server 12 communicate over a communication arrangement including hardware and software and which allows a bi-directional data exchange. More specifically, the communication arrangement has a first communication link 14 and a second communication link 16 that connect the workstation 10 and the server 12, respectively to a digital data network 18 such as the Internet.

The user interacts with the web site via a user interface that is implemented by the workstation 10. The user interface, which is preferably a graphical user interface, is designed to convey information to the user and also accept commands from the user. Information is conveyed to the user via a display. Information is input via a keyboard, pointing device, touch sensitive surface or speech recognition.

FIG. 1 also shows a workstation 20 which is connected to the server 12 via a communication link 22. The workstation 20 is similar in terms of operation and architecture to the workstation 10 and it is designed to receive reports about customer satisfaction regarding the web site. Note that in principle, the workstations 10 and 20 are interchangeable in the sense that the web site can be viewed from anyone of them. Similarly, the report about customer satisfaction can be sent to anyone of the workstations, not only the workstation 20. Also, anyone of the workstations 10 and 20 can be used simultaneously to visit the website and also to receive a report about customer satisfaction.

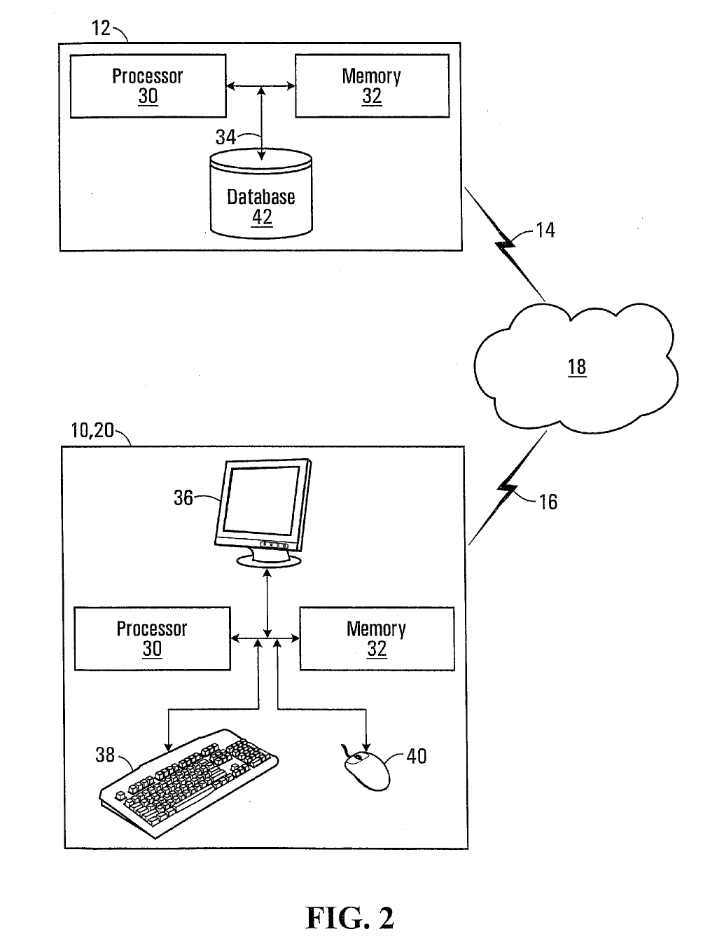

FIG. 2 is a general block diagram that illustrates the architecture of the workstation 10 and the architecture of the server 12. The server 12 is a computing platform that includes a processor 30 which executes software and which provides the core system functionality. The processor 30 communicates with a memory 32 in which are stored the program instructions executed by the processor 30 and also data on which processing is being performed. The server communicates with the database 42 over a communication link 34. Data that is stored in the database 42 or that is read from the database 42 is conveyed over the communication link 34.

The workstations 10 and 20 use a computing platform having a processor and a memory that is similar to the one used by the server 12 and for that reason the explanation above will not be repeated. In addition, the workstations 10, 20 have a hardware/software arrangement to allow the user to interact with the web site, view the customer satisfaction report, or both. The hardware/software arrangement includes a monitor 36 on which information is displayed, and input devices such as a keyboard 38 and a pointing device 40.

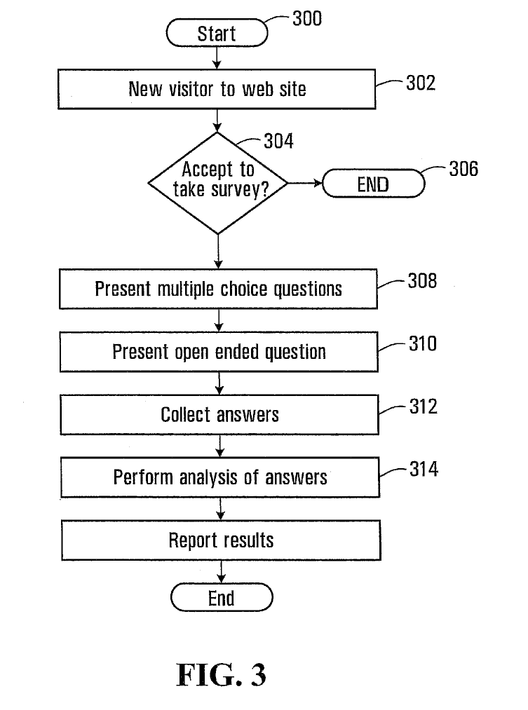

FIG. 3 is a flowchart that illustrates the steps that occur when a visitor browsing the web site participates in a survey intended to determine its degree of satisfaction with the site. The surveying process is implemented by software that typically would be run by the server 12.

The process starts at 300. At step 302 an online visitor, such as the user at the workstation 10 (shown in FIG. 1) starts browsing the web site. The surveying software asks the visitor at step 304 if he/she is willing to participate in the survey. This can be done by displaying to the user via the GUI a dialog box or any other appropriate information field that requests the user participation. The GUI provides a control that can be operated by the user allowing the user to indicate his/her acceptance of the invitation or rejection of the invitation. The control (not shown) can be a “clickable” button, for example that the user can activate via the pointing device 40.

Note that the surveying software typically would not invite every visitor to participate in the survey. Only a small proportion of the visitors would receive an invitation. Although a survey is designed to be as unintrusive as possible, it is generally not considered good practice to try engaging systematically every visitor with a survey request. One possibility is to randomly select the visitors that would be presented with an invitation.

If the visitor presented with an invitation to participate in the survey declines the invitation, the processing terminates at step 306. The visitor is then free to continue browsing the site at his/her leisure.

On the other hand if the visitor accepts the invitation, the surveying software will record the acceptance and the visitor will be presented with a survey at the end of their visit, or they can start the questionnaire at any time by accessing the survey application from the task bar. Note that it is generally desirable not to submit questions to the visitor immediately after he/she has accepted the invitation since at that time the visitor has not had the opportunity to explore the site and thus may not have an opinion on its positive aspects and negative aspects. It is considered advantageous to invite the visitor to take the survey shortly after the visitor has entered the site and then submit the questions just before the visitor is ready to leave the site.

The survey questions are submitted to the visitor in a series of succeeding information windows, such as dialog boxes. Each information window contains the questions and also GUI tools that allow the visitor to submit an answer. The tools can be “clickable” buttons or equivalent controls allowing the visitor to select an answer among a set of possible answers or fields where the visitor can type comments or answers.

In a specific example the questionnaire presents first multiple choice questions, at step 308. Multiple choice questions are questions that offer a specific number of answer choices and that require the visitor to select among those answer choices. The following are examples of questions that could be used in the context of a web site relating to automobiles:
Question—What is the purpose of the visit?
   Answer choices:
      Compare vehicles
      Research pricing
      View features
Question—When do you plan to purchase your next vehicle
   Answer choices:
      1-3 months
      3-6 months
      12+ months
      Not planning a purchase right now
Question—Which of the following groups include your age?
   Answer choices:
      Under 18
      18-27
      28-35
      36-50
      51 and older
Question—Based on your online experience how likely are you to visit a car dealership to request a test drive?
   Answer choices:
      Less likely
      No more likely
      Likely
      I have already done a test drive

Multiple choice questions are a form of closed-ended question since they are restrictive in the sense that there is a finite number of possible answers to each question.

Multiple choice questions can be structured to explore different aspect of the visitor's interaction with the web site and/or the business organization whose products and services are showcased by the web site. For example, the questions can be business oriented to elicit responses in connection with:
The relationship with the brand;
The primary purpose of the visit;
The path to the visit (how did the visitor find the web site;
The purchase horizon;
The category, brand or model of interest;
Future intention (purchase, test drive, request a quote, etc.)

The questions can also be customer oriented to provide more information about the profile of the visitor, such as:
Age;
Gender;
Income;
Household composition;

Also, the questions can be designed to obtain information on the visitor's perception of the web site, such as:
Navigation;
Content;
Interactivity;
Motivation;
Adoption;
Overall site satisfaction;

It should be expressly noted that the above are only examples and many other possibilities exist without departing from the spirit of the invention.

After the multiple choice questions have been run, the surveying software present to the visitor open ended questions, at step 310. The open ended questions are questions that allow the respondent to provide an opinion or answer by using their own words. The answer to the open ended question cannot be found in the questionnaire but has to be developed by the visitor. Open ended questions are also referred to as “infinite responses” questions, since each question can have an infinite number of response possibilities.

Open ended questions are useful in a survey since the respondent is not restricted to a finite number of choices, as such the questions can capture a wide variety of possible answers.

Examples of open ended questions include:
1. What did you like most about the website or business organization or the brand?
2. What did you dislike most about the website or business organization or the brand?
3. What is the reason for which you did not make a purchase?
4. What could be added to the web site to serve you better?

The GUI tools that allow the visitor to answer an open ended question include a text field in which the visitor can type the answer. The text field can be limited in size to restrict the length of the response. For example the text field can be designed to allow only responses that are less than 50 words.

Optionally, the GUI tool to capture the responses to open-ended questions may include functionality to record an answer uttered by the visitor. In this fashion, the visitor is not required to type anything but can simply state verbally the response in a microphone which records the audio. Another option is to provide video recording to capture the image of the visitor, in addition to the audio.

After the survey is completed, the answers to the multiple choice questions and the answers to the open-ended questions are collected at step 312. The answer data thus gathered is stored in the database 42 (FIG. 2) and stored for further processing.

The processing at step 314 is the analysis of the answers in order to build a customer satisfaction report. The analysis is a two step process that is performed by analysis software. The analysis software can be run by the server 12 or by any other computing entity that has access to the data stored in the database 42. The first step is an analysis of the answers provided to the multiple choice questions. This analysis can be done by using any suitable tool and would typically involve performing some sort of statistical analysis of the answers.

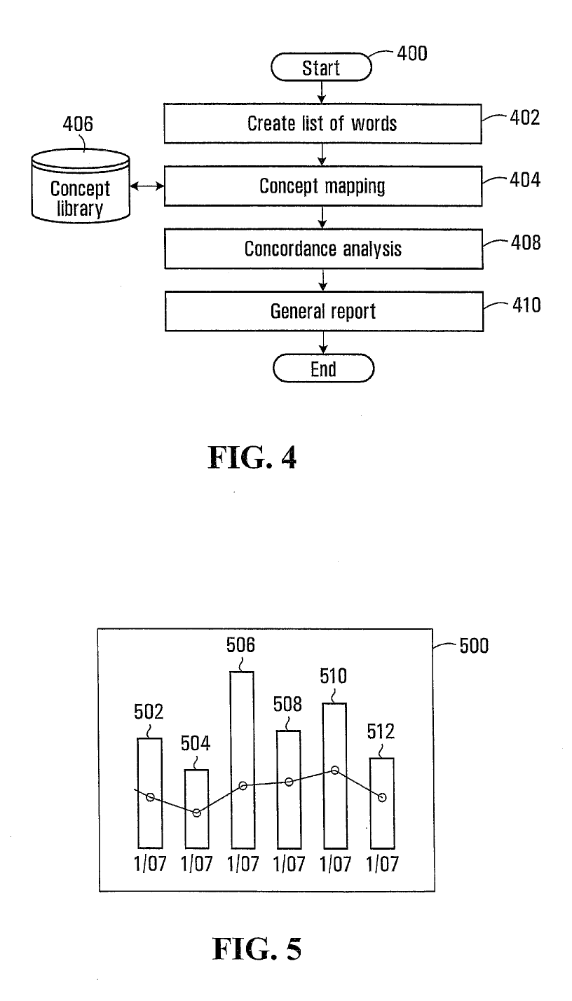

The second step of the process is an analysis of the open ended questions. This step is better illustrated by the flowchart at FIG. 4.

The process starts at 400. At step 402 the individual responses to open ended questions are parsed by the analysis software. The parsing operation breaks down the individual responses into words and then creates a list of the words and an associated frequency count. The list of the words and the associated frequency count is then supplied, at step 404 to a concept mapping algorithm that searches among the words list words that are representative of certain concepts reflecting what the respondent was trying to convey. The concepts can be descriptors, such as words used to identify or describe something or can be objects. For instance words such as like, liked, appreciate, are cool, are wicked, are descriptors that are associated with the concept like. Accordingly, the presence of anyone of those words in a response can be associated with the descriptor concept “like”, indicating that the respondent tried to convey something positive that he/she enjoyed.

Concepts that are objects are assessed in a similar fashion. Words like picture, pictures, pics, images, video, visuals and graphics can be associated with the object concept “picture”.

By identifying words in the responses and matching those to respective concepts a meaning can be extracted that is relevant from the perspective of customer satisfaction feedback.

The concepts against which words in the responses are being matched are stored in a concepts library 406. The concepts library is predefined and the definition could be done by a human operator or at least with human assistance. The concepts library 406 is matched to the context of the web site that is being surveyed. For instance a web site that sells or showcases computer products will use a different concepts library than a web site showcasing automobiles. Accordingly, the concepts library contains concepts that are related to the products that are promoted on the web site and also the characteristics of the web site that is being surveyed. For example, a web site selling computers is likely to use a concepts library with object concepts of the type:
Storage—relating to the storage capacity of the computers;
Laptop—portable computing;
Security—security of data;
Connectivity—ability of the computer to connect to other devices or networks;
Software—operating system or application software;
Printer;
Peripherals.

In contrast, the concepts library for use with a web site that promotes automobiles of a certain brand could use the following object concepts:
Power—relating to engine power;
Speed—relating to speed of the automobile;
Safety—relating to the safety of occupants;
Style—relating to the styling of the automobile;
Economy—relating to the fuel consumption of the automobile.

A concept library can also contain object concepts directed to the actual web site and that reflect elements relevant to the web site performance, ease of navigation, etc. . . . , which are distinct from the products or services that are promoted or commercialized on the web site. Accordingly those object concepts are likely to be common to concept libraries for web sites that showcase or commercialize different products and services.

The concept library 406 can be designed to hold a list of concepts and the associated list of words that are matched to that concept. Accordingly, the data structure that holds the concept library information maps each of the concepts to a list of words that the designer of the library considers to be representative of the concepts. Alternatively, the concept library 406 can only contain the concepts and use grammatical analysis software that can determine if anyone of the words present can be considered a match for anyone of the concepts.

Once the concept mapping has been completed, the processing continues at step 408 where a concordance analysis is made. Concordance looks for concepts that are closely related spatially in the text flow. For example examining the concept ‘like’ the program will look to a preset number of terms left and right of the concept being concorded to find related concepts. Once concepts are concorded (related spatially) they have much more context and therefore meaning. These concorded pair concepts are then mapped to the most representative quantitative rating within the multiple-choice section of the research that measures attributes of the web site experience. This mapping can be done on the basis of pre-set mapping logic which links concepts to attributes and then to a certain rating for an attribute. For instance a pair of concepts A and B, are linked by the mapping logic to rating 1 (among say 5 possible ratings) of attribute C.

One of the purposes of the concordance analysis is to classify the various concepts identified in the responses to the open-ended questions and determine their relative importance. In other words, the concordance analysis tries to find the concepts that have been expressed the most often in the pool of answers. This is a statistical analysis that looks mainly for the percentage of occurrences of certain concepts, the percentage of respondents that conveyed those concepts or any other metric that can express the degree to which those concepts matter to the population of respondents.

It should be expressly noted that while the specification describes a specific manner in which the analysis of the responses to the open ended questions is performed, this is only an example and other ways of analyzing the responses can be done without departing from the spirit of the invention. Alternative analysis techniques may be purely automated, somewhat automated or require a substantial amount of human intervention. In the case where the number of answers is relatively small, it is feasible to rely on a human to interpret the responses and then classify them to reflect the concept or concepts that the respondents conveyed.

A report that conveys the consumer satisfaction in connection with the web site is generated at step 410. The report includes both consumer satisfaction data, expressed according to any suitable consumer satisfaction metric and also tools that allow the reader of the report to navigate to the answers to the open ended questions associated with the particular consumer satisfaction metric.

Note that the consumer satisfaction data may reflect consumer satisfaction in connection with the intrinsic properties or attributes of the web site, such as ease of navigation, quality and accessibility of the information presented, esthetical qualities and speed of access, among others. The consumer satisfaction data can also reflect consumer satisfaction in connection with the products or services that are being presented, commercialized or showcased on the web site. Examples would include the value of the products as perceived by a visitor, the performance of the products, their durability or quality, among others. Also the consumer satisfaction data may reflect consumer satisfaction on both levels, such as at the web site level and the product and services level.

Ultimately, the consumer satisfaction data, as expressed by one or more consumer satisfaction metrics is directly linked to the concepts extracted during the processing at step 314. In other words, a consumer satisfaction metric is related to one or more concepts. In this fashion, particular answers to the open-ended questions can be related to one or more consumer satisfaction metrics via the concepts by the operation of the pre-set mapping logic described earlier.

The report can be viewed at the workstation 20 via the GUI. In particular, the information, such as the consumer satisfaction metrics can be displayed on the monitor 36, while the navigation tools can be activated via the keyboard 38 and/or pointing device 40.

An example of a report is shown in FIGS. 5 to 8. Those figures are on-screen displays of the GUI that the user will see when consulting the report along with the tools allowing access to the raw data.

FIG. 5 shows a graphical representation of a consumer satisfaction metric. In this example the consumer satisfaction metric relates to the notion of discovery, which reflects the ease, as perceived by the respondents, to find information on the web site. The discovery metric can be generated on the basis of the multiple choice questions, the open ended questions or both.

The discovery metric is illustrated in the form of graph but can also be depicted in a format that is not a graph. Data shown in a table would be a format that is not a graph. If a graphical representation is chosen, various possibilities exist, such as a bar graph, a histogram, a pie chart, a curve, data points scattered, a space and area under a curve, among others.

The graph 500 is comprised of a plurality of information elements. In the example shown each information element reflects the customer satisfaction metric in relation to a factor, which is time. Accordingly, the graph 500 has 6 information elements 502, 504, 506, 508, 510 and 512 and each information element is associated to a two month time period. The information element 502 is associated with a time period spanning January 2007 to March 2007, the information element 504 is associated with a time period spanning March 2007 to May 2007, the information element 506 is associated with a time period spanning May 2007 to July 2007, the information element 508 is associated with a time period spanning July 2007 to September 2007, the information element 510 is associated with a time period spanning September 2007 to November 2007.

Note that the factor associated with each element of information can be something else than time. In the context of discovery the factor can be a certain type of products or service. In such case, the discovery metric would be presented according to a product or service to reflect the easiness to find information for product A, product B, service A, service B, etc.

The graph 500 includes at least one control operable by the user in order to invoke the data access function that provides access to the underlying responses to the open-ended questions. The control may be a text or graphic element that the user can activate which will invoke the data access function. The control can be activated via the pointer device 40, the keyboard 38 or in any other suitable manner. In this example, the graph has 6 independent controls, each control being associated with an information element 502, 504, 506, 508, 510 and 512. A control in connection with an information element 502, 504, 506, 508, 510 and 512 can be activated by “clicking” anywhere in the area defining the information element.

For example, assume the user clicks on the information element 502. As a result of this action the data access function is invoked. The user is then presented with a filter control to provide parameters allowing isolating a specific subset of the underlying answers to the open-ended questions. The filter control can be a single level filter control or multi-level filter control. In other words a single level filter control would use a single criterion to isolate the subset of underlying the raw data while a multi-level filter control would use multiple criteria to isolate the subset of underlying raw data.

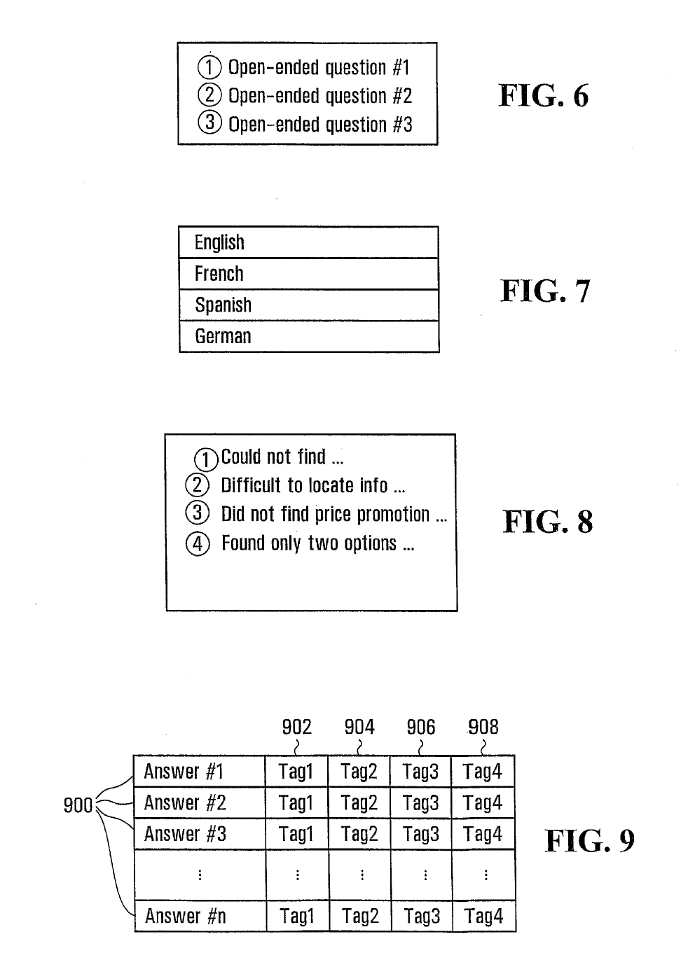

FIG. 6 and FIG. 7 show a dual level filter control. In FIG. 6, the user is presented on the display 36 with a selection of the open ended questions used in the survey. The user can pick anyone of those questions and eventually be directed to the answers on the basis of which the discovery metric was generated. The open-ended questions are presented in a list format and user can pick anyone of them. There is also a suitable control operable by the user via the keyboard 38 and/or mouse 40 to indicate the selection.

FIG. 7 illustrates the second level of the filtering control. In this example the filtering is done on the basis of the language in which the responses to the open ended question where done. The user is presented in a list format with all the possible languages in which responses where presented and he/she can pick the language of choice. There is also a suitable control operable by the user via the keyboard 38 and/or mouse 40 to indicate the language selection.

Once all the filtering control levels have been properly set, the user is brought to the results page that shows in a list format all the responses to the open ended questions that fit the selection criteria, namely:
1. Responses provided during the period associated with the information element 502, which spans January 2007 to March 2007;
2. Responses to the open-ended question selected at filtering control level of FIG. 6;
3. Responses in the language selected at the filtering control level of FIG. 7;
4. Responses associated with the notion of discovery.

The results page is shown in FIG. 8. The answers to the open ended questions that meet all the selection criteria appear in a list format and can be easily viewed.

The ability for a manager or administrator to drill down to the raw data is advantageous since it allows understanding the reasons behind up or down movements in the consumer satisfaction metric that is being considered. For example, by looking at the information element 508 in FIG. 5, it is apparent that the discovery metric has slipped by comparison to the previous three month reporting period (information element 506). In a real life situation many reasons can explain this variation and it may not be easy to isolate the key factors. The answers to the open-ended question convey, in this context very valuable information since they truly reflect how visitors felt about the discovery aspect of the web site. Accordingly, those answers provide to the manager or administrators clear reasons or at least some clues as to why a larger group of visitors is less enthusiastic about the discovery aspect of the web site. In turn, the manager or administrator can implement changes on the web site that can improve the perception among the visitor's population. By continuously surveying the site it is therefore possible to determine the effect of those changes.

FIG. 9 illustrates the data structure of the database 42, in particular the logical relationships between the answers to the open ended questions and the reported customer satisfaction metric. The relationship is such that it provides a convenient manner of extracting the raw data on the basis of which the customer satisfaction metric has been generated.

All the answers to the open ended questions that are collected during the surveying operation are stored in the database, preferably integrally without any modification to the text. Each answer 900 constitutes a record in the database. The record is associated with a number of different tags which allow the answer to be properly classified and thus retrieved later. The number and the structure of the tags is a matter of choice and it is likely to vary according to the specific implementation. In the example shown each record 900 is characterized by four tags, 902, 904, 906 and 908. The tags 902, 904, 906 and 908 are as follows:
1. The tag 902 links the record to the concorded concepts that are conveyed by the response. This tag 902 is generated as a result of the processing performed at step 314 in FIG. 3. Recall that the concept are also tied to the different consumer satisfaction metrics, accordingly the tag 902 links the answer 900 to on more consumer satisfaction metrics;
2. The tag 904 links the answer 900 to a particular reporting period. Simply stated, the tag 904 can be the date at which the answer 900 was provided;
3. The tag 906 links the answer 900 to a particular open-ended question;
4. The tag 908 indicates the language in which the answer 900 is provided.

The term “link” refers to a logical connection between different pieces of information and is not limited to any particular linking mechanism.

Note that while the drawings show four tags 902, 904, 906 and 908, more or less than four tags can be used without departing from the spirit of the invention.

This structure allows identifying easily in the database 42 the answers that are related to any particular information element in the graph of FIG. 5, filter the answers according to the criteria defined by the user and present the results of the filtering operation.

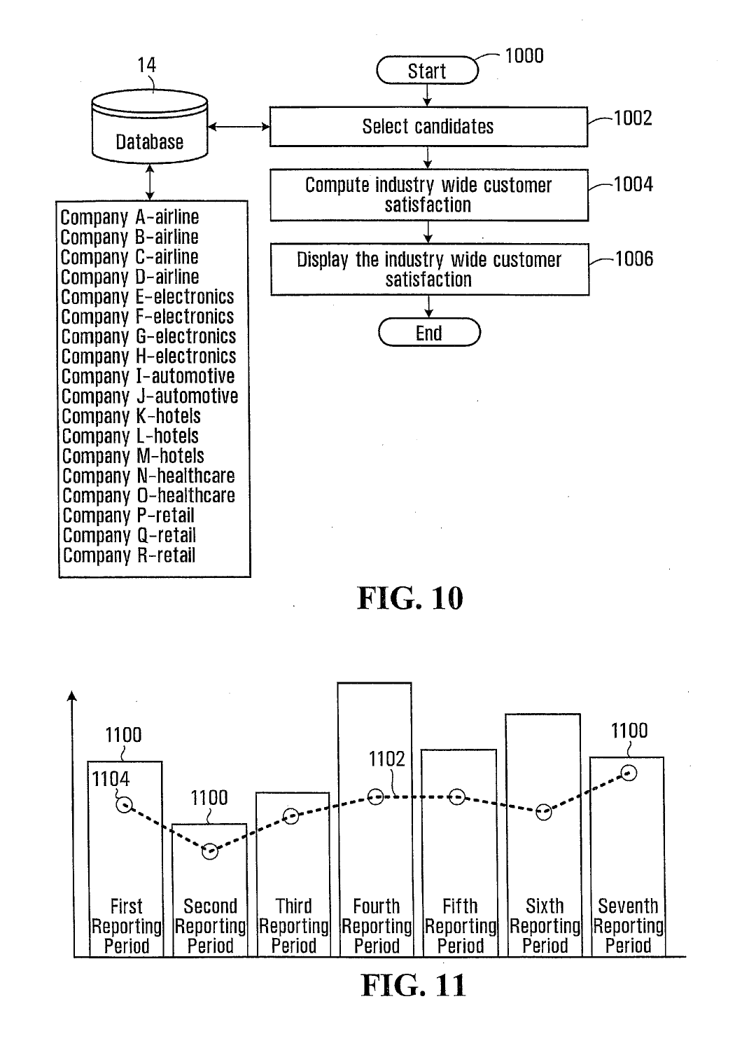

In a possible variant described by the flowchart in FIG. 10, the consumer satisfaction data is presented to the user in a particular context that enhances the understanding of the information delivered. The context is established by presenting consumer satisfaction data that spans a plurality of business organizations, that have similar product or service offerings as the one for which the main consumer satisfaction data is shown. In this example, the context therefore shows consumer satisfaction data derived from a plurality of analogous sources and for the purposes of this specification it will be referred to as “industry wide consumer satisfaction data”.

Consider for the sake of this example, a web site relating to an airline company A. The airline company A provides to visitors information on flights. Also, a visitor can purchase tickets on by web site by selecting the destination and date of departure and date of return. A customer satisfaction data can be collected on the web site as discussed earlier, for instance by running on-line surveys having questions, that can be multiple choice, open-ended or a combination of multiple choice and open ended. To establish a contextual information, in particular an industry wide consumer satisfaction data, customer satisfaction data from several airline companies, that are similar in terms of profile of products and services offered to company A, are used.

The process, which can be implemented by the server 12 starts at 1000. At step 1002, the process selects the candidates that will be used to establish the contextual information, namely the industry wide customer satisfaction data. Assume for the sake of this example that the database 42 contains consumer satisfaction data in connection with the web sites of 18 different business organizations. In each case the data has been collected independently by using online surveys. The customer satisfaction data breaks down as follows:
1. Company A—airline
2. Company B—airline
3. Company C—airline
4. Company D—airline
5. Company E—electronics
6. Company F—electronics
7. Company G—electronics
8. Company H—electronics
9. Company I automotive
10. Company J—automotive
11. Company K—hotels
12. Company L—hotels
13. Company M—hotels
14. Company N—healthcare
15. Company O healthcare
16. Company P retail
17. Company Q retail
18. Company R retail

In each case the customer satisfaction data can be expressed by using a range of different metrics, examples of which were provided earlier.

When a customer satisfaction report is to be generated for, say Company A, step 1002 will identify analogous business organizations that can be used to generate the contextual information. In one example, this association could be only at the category level not specific companies, for example ‘Automotive industry’ or organizations with revenue more then 100,000,00, or organizations to sell directly online. The selection can be manual or automatic. The list of companies in the database 42 contains four companies that have activities related to air transport, namely Companies A, B. C and D. Companies A, B and C are passenger transport companies while company D is an air cargo company.

One possibility is to pool the customer satisfaction data from companies A, B, C and D in order to create the industry wide customer satisfaction data. Another option is to use only the data from Companies A, B and C since they all have common activities, while company D focuses on something different (passenger vs. cargo). The first option would provide a very focused industry wide customer satisfaction data while the second option would have the benefit of providing a broader data set from which the industry wide customer satisfaction data is produced, but the data would not be as relevant as in the first case.

Other possibilities exist as well. For example, the data set from which the industry wide consumer satisfaction data is produced can be expanded to include all the organizations in the area of services, in contract to manufacturing organizations. In such case, the process will pool together companies A, B, C and D (airline), companies K and L (hotels), companies N and O (healthcare) and companies P, Q and R (retail).

It will be appreciated that many options exist in grouping different companies together to establish contextual information. The grouping can be done narrowly or widely largely on the basis of the intended application.

Continuing with the above example, assume that companies A, B, C and D are to be grouped to produce the industry wide customer satisfaction data. This is shown at step 1004 in FIG. 10. The processing involves taking the customer satisfaction data computed for each company and combining them to create the industry wide customer satisfaction data. The combination can be done in many different ways. According to one possibility the industry wide customer satisfaction data is broken down in terms of individual metrics. Accordingly, the industry wide customer satisfaction data would comprise one or more industry wide customer satisfaction values, each value corresponding to a certain metric. Examples of metrics which are related directly to the web site include discovery, ease of navigation, quality and accessibility of the information presented on the web site, esthetical qualities and speed of access, among others. Example of metrics in connection with the products or services that are being presented, commercialized or showcased on the web site would include the performance of the products, their durability or quality and reputation of the brand, and quality of service among others.

Consider the example where the industry wide consumer satisfaction data is expressed in terms of the following metrics:
1. discovery;
2. ease of navigation;
3. speed of access;

For each metric the process extracts the value or values for each company, namely company A, B, C and D that have been computed earlier and that are stored in the database 14. After the individual values are extracted they are combined to create an industry wide customer satisfaction metric. The combination includes a statistical processing of the individual values, such as averaging the values, computing a maximum, a minimum or both, among others. Therefore, the processing would produce an industry wide customer satisfaction metric data for discovery, ease of navigation and speed of access. Note that in each case, the industry wide customer satisfaction metric data may include a set of values and not merely a single value. In that set of values, each value relates the metric to a certain parameter, such as time, type of product or service, etc. Hence, in the case of a time parameter, the set of values would include a value for a particular industry wide customer satisfaction metric, associated with a certain reporting period. Take again the example of discovery. The set of values would include several values, each associated with a reporting period, which can be of 2 months. The first value in the set would, therefore, indicate the industry wide customer satisfaction value for the discovery metric assessed over a two month period, the second value would reflect the metric assessed over a subsequent two month period, etc.

The industry wide customer satisfaction data is displayed to the customer at step 1006. The display can be done separately to show only that date or it can be combined with other information. An example of combination is shown in FIG. 11, where the industry wide customer satisfaction values for discovery is shown as an overlay to the company specific customer satisfaction values for the same metric. This example is best illustrated in FIG. 11. The company specific information, say company A, is shown by the bar graph where each bar 1100 shows the value associated with discovery over a certain reporting period. Each bar, therefore reflects how online visitors rate the discovery aspect of company A's web site during the associated reporting period. The industry wide information is shown as a dashed line 1102. The dashed line has a series of data points 1104 where each data point registers with a bar and corresponds to a value that reflects how online visitors rate the discovery aspect of web sites in the airline industry. Therefore each dashed line provides a comparison for the aspect of discovery for the given reporting period.

Optionally, the industry wide information can be presented separately from the company specific information.

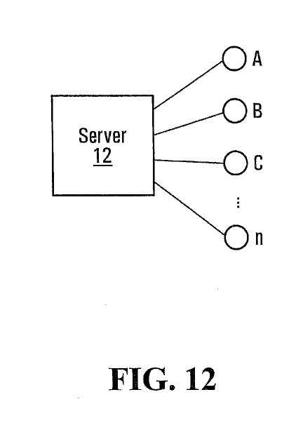

FIG. 12 is a block diagram that illustrates an example of an infrastructure for collecting the industry wide information.

The infrastructure includes a server, such as the server 12 that receives information from a plurality of sources A to n. Each information source captures customer feedback in the context of an on-line experience associated with a given web-site. For instance, source A would generate customer feedback, produced by an online survey ran on the website of company A, source B would generate customer feedback, produced by an online survey ran on the website of company B, etc. The customer feedback could include answers to multiple choice questions, open-ended questions or both.

The customer feedback data set derived from each source is therefore, very similar or identical to the information collected via the workstation 10. The customer feedback data set collected from each source A, B, C . . . n is maintained separate in the server 12 and processed independently from each other. The processing can be the same as the one discussed earlier in connection with the flowchart of FIG. 4 or can be somewhat different. The thus processed customer feedback data sets provide the basis for establishing the industry wide contextual information against which a particular one of the data sets can be illustrated in a report.

Note that in establishing the contextual information from the customer feedback data sets, sensitive information that may not be useful or desirable to include in the contextual information is removed. Examples of sensitive information to remove could be the identify of the data sources, such as the names of the business organizations whose web-sites are being surveyed.

Continuing with the above example, the processing by the server 12 would, therefore generate contextual information based on the customer feedback data sets A, B, C . . . n. Individual reports, say for the website associated with source A, would allow to present the specific customer feedback data set from source A against a contextual background made from data sets A, B, C . . . n. Similarly, a report would be generated presenting the customer feedback data from the website associated with the source B against the contextual background, etc.

Reverting back to FIG. 11 it can be appreciated that the use of the industry wide information is advantageous since it provides a basis for comparison against which the company specific information can be assessed. For instance, it can be seen that for the fifth reporting period, the discovery rating of the web site of company A has significantly dropped relative to the fourth reporting period. This rating change may be due to a lot of factors including the performance of the web site of company A in terms of discovery but also trends and movements across the whole industry. In particular, the industry wide information shows that the ratings have remained generally static during the fourth and fifth reporting period and while there is no drop there is no increase either but most importantly, company A is doing better than the industry as a whole.

The ability to provide to the reader industry wide customer satisfaction information and optionally to combine that information with company specific customer specific information provides numerous advantages by creating a context in which the company specific information can be better understood.

Note that both the specific customer feedback, such as the company specific information as per the example of FIG. 11 and the industry wide information are both developed from a common set of data, namely the sources A, B, C . . . n (FIG. 12). Accordingly, any update to the company specific information that can be done, such as when new data is delivered from the respective source A, B, C . . . n, the impact of the new data affects the company specific information and also the industry wide information. This change occurs in real time. Accordingly, it is possible to produce reports in real time about anyone of the companies associated with sources A, B, C . . . n that show real time customer feedback data and at the same time illustrate the results against industry wide information that is also produced in real time.

Although various embodiments have been illustrated, this was for the purpose of describing, but not limiting, the invention. Various modifications will become apparent to those skilled in the art and are within the scope of this invention, which is defined more particularly by the attached claims.

1) A graphical user interface implemented on a computer, comprising:
a) an information area displaying customer satisfaction data generated on the basis of on-line surveys through application of a questionnaire to visitors of a web site, wherein the questionnaire includes open-ended questions;
b) a control operable by a user at the computer to display answers provided by the visitors to the open-ended questions.

2) A graphical user interface as defined in claim 1, wherein the customer satisfaction data is displayed in a graph.

3) A graphical user interface as defined in claim 2, wherein the data displayed in a graph expresses the customer satisfaction data according to a certain metric.

4) A graphical user interface as defined in claim 3, wherein the certain metric is selected in the group consisting of discovery of the web site, ease of navigation of the web site, quality of the information presented on the web site, esthetical qualities of the web site, speed of access of the web site, performance of the products and/or services showcased on the web site, quality of the products and/or services showcased on the web site, reputation of the brand of the products and/or services showcased on the web site, and quality of service of the products showcased on the web site.

5) A graphical user interface as defined in claim 3, wherein the data displayed in the graph includes a plurality of information elements.

6) A graphical user interface as defined in claim 5, wherein each information element represents a value for the certain metric.

7) A graphical user interface as defined in claim 6, wherein each information element is associated to a factor displayed in the information area.

8) A graphical user interface as defined in claim 7, wherein the factor is time.

9) A graphical user interface as defined in claim 8, wherein the information area includes a first control, wherein the first control, upon activation by the user invokes a second information area presenting the user with at least one filtering option to filter a pool of responses to open-ended questions.

10) A graphical user interface as defined in claim 9, wherein the filtering option includes a second control allowing the user to select an open ended-question among a set of open-ended questions, wherein a selection of a particular one of the open-ended questions among the set of open-ended questions restricts the display of answers to answers to the particular one of the open-ended questions.

11) A graphical user interface as defined in claim 9, wherein the filtering option includes a second control allowing the user to select a language among a set of languages, wherein a selection of a particular one of the languages among the set of languages restricts the display of answers to answers in the particular one of the languages.

12) A graphical user interface as defined in claim 5, including a plurality of controls, where each control is operable by a user at the computer to display a particular sub-set of answers from a set of answers provided by the visitors to the open-ended questions.

13) A graphical user interface as defined in claim 12, wherein each control is associated with an information element and wherein each information element represents a value for the certain metric within a certain reporting time period, wherein the control associated with a particular one of the information elements, when activated allows displaying answers to open-ended questions provided during the reporting period of the particular one of the information elements.

14) A graphical user interface as defined in claim 1, wherein the survey includes multiple-choice questions and open-ended questions.

15) A computer readable storage medium including a program for execution by a computer to implement a graphical user interface including:
a) an information area displaying customer satisfaction data generated on the basis of on-line surveys of visitors of a web site, wherein the online survey includes open-ended questions;
b) a control operable by a user at the computer to display answers provided by the visitors to the open-ended questions.

16) A method for collecting and presenting customer satisfaction data, the method including:
a) running an on-line survey through application of a questionnaire to visitors of a web site, wherein the questionnaire includes open-ended questions;
b) processing the responses to the questionnaire to generate customer satisfaction data;
c) creating a link in a database between the customer satisfaction data and answers provided by visitors to open-ended questions of the questionnaire;
d) displaying at a computer via a graphical user interface the customer satisfaction data;
e) providing the graphical user interface with a control, the control when operated by the user using link to cause display to the user at the computer of answers to the open-ended questions.

17) A method as defined in claim 16, including displaying the customer satisfaction data in a graph.

18) A method as defined in claim 17, wherein the data displayed in graphical form expresses the customer satisfaction data according to a certain metric.

19) A method as defined in claim 18, wherein the certain metric is selected in the group consisting of discovery of the web site, ease of navigation of the web site, quality of the information presented on the web site, esthetical qualities of the web site, speed of access of the web site, performance of the products and/or services showcased on the web site, quality of the products and/or services showcased on the web site, reputation of the brand of the products and/or services showcased on the web site, and quality of service of the products showcased on the web site.

20) A method as defined in claim 18, wherein the data displayed in graphical form includes a plurality of information elements.

21) A method as defined in claim 20, wherein each information element represents a value for the certain metric.

22) A method as defined in claim 21, wherein each information element is associated to a factor displayed in the information area.

23) A method as defined in claim 22, wherein the factor is time.

24) A method as defined in claim 23, wherein the information area is a first information area, and wherein the method includes upon activation of the control presenting a second information area presenting the user with at least one filtering option to filter a set of responses to open-ended questions.

25) A method as defined in claim 24, wherein the filtering option includes a control allowing the user to select an open ended-question among a set of open-ended questions, wherein a selection of a particular one of the open-ended questions among the set of open-ended questions restricts the display of answers to answers to the particular one of the open-ended questions.

26) A method as defined in claim 24, wherein the filtering option includes a control allowing the user to select a language among a set of languages, wherein a selection of a particular one of the languages among the set of languages restricts the display of answers to answers in the particular one of the languages.

27) A method as defined in claim 20, including the graphical user interface with a plurality of controls, where each control is operable by a user at the computer to display a particular sub-set of answers from a pool of answers provided by the visitors to the open-ended questions.

28) A method as defined in claim 27, wherein each control is associated with an information element and wherein each information element represents a value for the certain metric within a certain reporting time period, wherein the control associated with a particular one of the information elements, when activated allows displaying answers to open-ended questions provided during the reporting period of the particular one of the information elements.

29) A method as defined in claim 16, wherein the survey includes multiple-choice questions and open-ended questions.

30) A graphical user interface implemented on a computer, comprising:
a) a first information area displaying a company specific customer satisfaction data generated on the basis of an on-line survey through application of a questionnaire to visitors of a web site of the company;
b) a second information area displaying industry wide customer satisfaction data generated on the basis of surveys of web sites of a plurality of companies.

31) A graphical user interface as defined in claim 30, wherein the company specific customer satisfaction data is displayed in a graph.

32) A graphical user interface as defined in claim 31, wherein the industry wide customer satisfaction data is displayed in a graph.

33) A graphical user interface as defined in claim 32, wherein the company specific customer satisfaction data and the industry wide customer satisfaction data are overlaid.

34) A graphical user interface as defined in claim 30, wherein the company on the basis of which the customer specific customer satisfaction data is generated and the plurality of companies on the basis of which the industry wide customer satisfaction data is generated belong to a common industry sector.

35) A graphical user interface as defined in claim 30, wherein the company on the basis of which the customer specific customer satisfaction data is generated and the plurality of companies on the basis of which the industry wide customer satisfaction data is generated commercialize the same class of products and/or services.

36) A graphical user interface as defined in claim 30, wherein the company on the basis of which the customer specific customer satisfaction data is generated and the plurality of companies on the basis of which the industry wide customer satisfaction data is generated belong to the service sector.

37) A graphical user interface as defined in claim 30, wherein the company specific customer satisfaction data expresses the company specific customer satisfaction data according to a certain metric.

38) A graphical user interface as defined in claim 37, wherein the certain metric is selected in the group consisting of discovery of the web site, ease of navigation of the web site, quality of the information presented on the web site, esthetical qualities of the web site, speed of access of the web site, performance of the products and/or services showcased on the web site, quality of the products and/or services showcased on the web site, reputation of the brand of the products and/or services showcased on the web site, and quality of service of the products showcased on the web site.

39) A graphical user interface as defined in claim 37, wherein the company specific customer satisfaction data includes a plurality of information elements.

40) A graphical user interface as defined in claim 39, wherein each information element represents a value for the certain metric.

41) A graphical user interface as defined in claim 40, wherein each information element is associated to a factor displayed in the information area.

42) A graphical user interface as defined in claim 41, wherein the factor is time.

43) A graphical user interface as defined in claim 30, wherein the industry wide customer satisfaction data expresses the industry wide customer satisfaction data according to a certain metric.

44) A graphical user interface as defined in claim 43, wherein the certain metric is selected in the group consisting of discovery of the web site, ease of navigation of the web site, quality of the information presented on the web site, esthetical qualities of the web site, speed of access of the web site, performance of the products and/or services showcased on the web site, quality of the products and/or services showcased on the web site, reputation of the brand of the products and/or services showcased on the web site, and quality of service of the products showcased on the web site.

45) A graphical user interface as defined in claim 44, wherein the industry wide customer satisfaction data includes a plurality of information elements.

46) A graphical user interface as defined in claim 45, wherein each information element represents a value for the certain metric.

47) A graphical user interface as defined in claim 46, wherein each information element is associated to a factor displayed in the second information area.

48) A graphical user interface as defined in claim 47, wherein the factor is time.

49) A graphical user interface as defined in claim 30, wherein the company specific customer satisfaction data and the industry wide customer satisfaction data are expressed according to a common metric.

50) A graphical user interface as defined in claim 49, wherein:
a) the company specific customer satisfaction data includes a first set of information areas, each information area in the firsts set expressing a value of the common metric;
b); the industry wide customer satisfaction data includes a second set of information areas, each information area in the second set expressing a value of the common metric;
c) the display of the first and second information areas being such that an information area in the first set being related to an information area in the second set via a common factor.

51) A graphical user interface as defined in claim 50, wherein the common factor is related to time.

52) A computer readable storage medium including a program for execution by a computer to implement a graphical user interface including:
a) a first information area displaying a company specific customer satisfaction data generated on the basis of an on-line survey through application of a questionnaire to visitors of a web site of the company;
b) a second information area displaying industry wide customer satisfaction data generated on the basis of surveys of web sites of a plurality of companies.

53) A method for collecting and presenting customer satisfaction data, the method including:
a) running an on-line survey through application of a questionnaire to visitors of a web site associated with a certain company;
b) processing the responses to the questionnaire to generate company specific customer satisfaction data;
c) producing industry wide customer satisfaction data generated on the basis of surveys of web sites of a plurality of companies;
d) displaying at a computer via a graphical user interface the company specific and the industry wide customer satisfaction data, the displaying including:
i) providing a first information area displaying the company specific customer satisfaction data;
ii) providing a second information area displaying the industry wide customer satisfaction data.

54) A method as defined in claim 53, including:
a) running a plurality of on-line surveys through application of questionnaires to visitors of web sites associated with respective companies;
b) processing the responses to the questionnaires to:
i) generate industry wide customer satisfaction data;
ii) generate a plurality of company specific customer satisfaction data;
c) displaying at respective computers one of the company specific customer satisfaction data and the industry wide customer satisfaction data.
